(19) United States
(12) Patent Application Publication
(10) Pub. No.: US 2022/0211151 A1
(43) Pub. Date: Jul. 7, 2022

(54) PERSONAL CASE WITH CHARGING SYSTEM

(71) Applicant: Roger Yang, Pomona, CA (US)

(72) Inventor: Chenhua Chen, Chino Hills, CA (US)

(73) Assignee: Roger Yang, Pomona, CA (US)

(21) Appl. No.: 17/700,355

(22) Filed: Mar. 21, 2022

Related U.S. Application Data
(63) Continuation of application No. 16/720,593, filed on Dec. 19, 2019.

(51) Int. Cl. A45C 5/03; A45C 5/14; H02J 7/00; A45C 13/26; A45C 15/00

(52) U.S. Cl. CPC A45C 5/03; A45C 5/14; A45C 15/00; A45C 13/262; H02J 7/0045

(57) ABSTRACT

A personal case defined by a stiff shell section including an elongate hole therethrough. There is a flexible sheet attached to the stiff shell section across the elongate hole with an elongate slit therethrough. A pocket fixed within the stiff shell section is accessed through the elongate slit and retained by a closure. A charging cable includes a charging port fixed on the case and a plug in the pocket to engage a power bank.

### PRIORITY

This is a continuation of U.S. patent application Ser. No. 16/720,593, filed Dec. 19, 2019, the disclosure of which is incorporated herein by reference.

### BACKGROUND OF THE INVENTION

The field of the present invention is personal cases.

On trips and extended excursions, battery capacity on small personal electronics such as cellphones and portable computers can become logistically limiting. Rechargeable batteries separate from the electronics are available but detract from the convenience of the electronics. When burdened with personal effects, luggage and the like, inconvenience can increase.

### SUMMARY OF THE INVENTION

The present invention is directed to a personal case with a stiff shell. The shell has a hole therethrough closed by a flexible sheet having a slit. The slit provides access to a pocket within the shell and includes a closure. A charging cable extends through the case from charging port to a plug in the pocket. A power bank can be placed in the pocket and engaged with the plug.

Accordingly, it is an object of the present invention to provide auxiliary power for personal electronics when traveling. Other and further objects and advantages will appear hereafter.

### BRIEF DESCRIPTION OF THE DRAWINGS

FIG. 1 is a top view of a personal case;

FIG. 2 is an isometric view of the personal case of FIG. 1;

FIG. 3 is an isometric detail view of the personal case of FIG. 1 illustrating the charging system;

FIG. 4 is a schematic cross-sectional view of the construction of the charging system in relationship with the personal case;

FIG. 4A is a detail of FIG. 4 showing a second closure;

FIG. 4B is a detail of FIG. 4 showing a third closure;

FIG. 4C is a detail of FIG. 4 showing a fourth closure;

### DETAILED DESCRIPTION OF THE PREFERRED EMBODIMENT

Turning in detail to the drawings, a personal case 10 is shown in one embodiment to be a rolling suitcase. The case 10 may be a container of almost infinite variety having a stiff shell section for mounting. The embodiment of the case 10 that is exemplified here reflects the utility of the present device with travel, where electronic device charging opportunities are limited. The case 10 may advantageously apply to, for example, briefcases which are also likely to be carried away from charging opportunities.

The personal case 10 shown has a stiff shell divided in two container portions 12, 14 joined by a traditional zipper closure 16. Four trucks 18 provide for rolling of the case 10 and two handles 20, 22 provide purchase for carrying. An extendable handle 24 facilitates guiding the case when rolling on the trucks 18.

An elongate hole 26 extends through a stiff shell section of the case 10. The location of the elongate hole 26 may be chosen by preference. It is thought that placement on the top of the case 10 as shown in the Figures is most convenient. Another useful position is on the case adjacent the handle 22 on the side of the case.

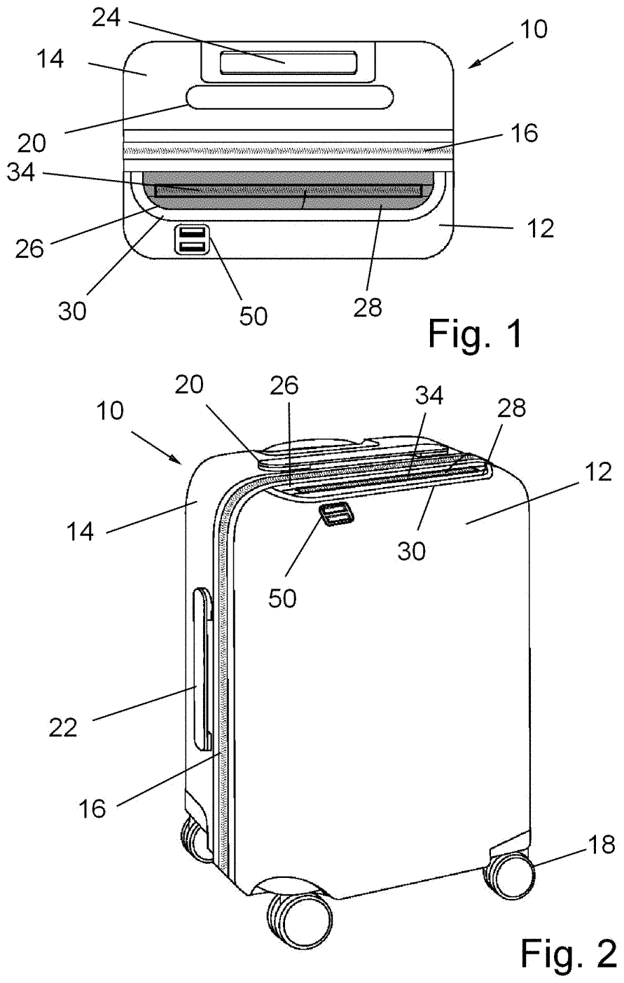

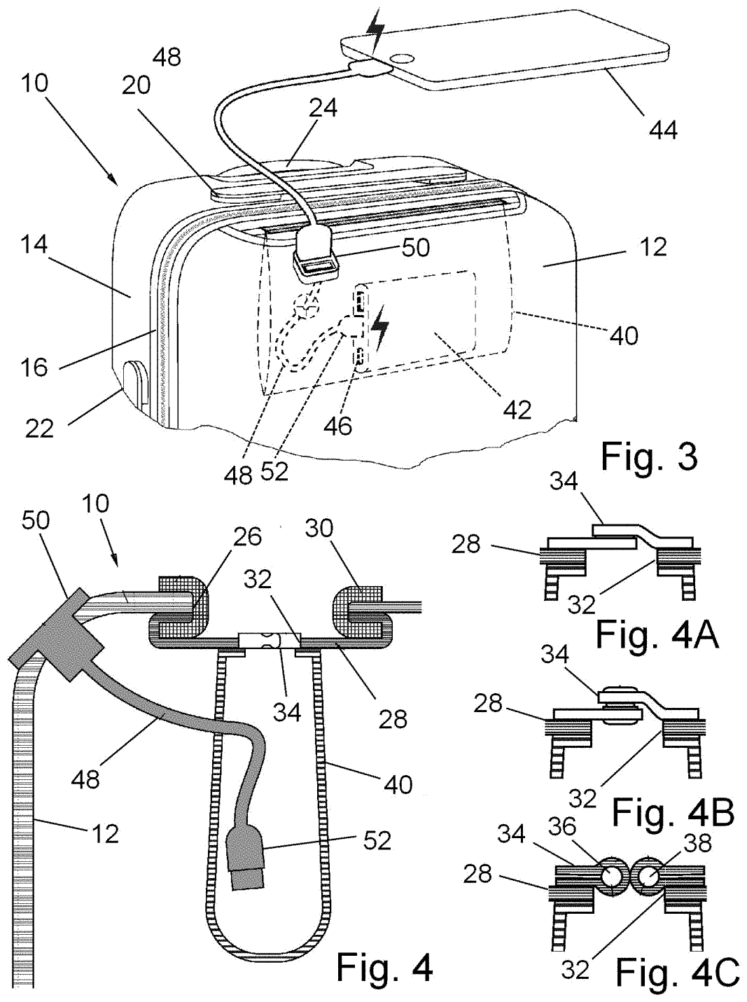

The elongate hole 26 is closed by a flexible sheet 28 which can be distorted in use. The sheet 28 is bound about its periphery to the case 10 at the periphery of the elongate hole 26 by binding 30. Other methods of attachment may also be employed. The sheet 28 includes an elongate slit 32 displaced from the periphery of the sheet 28 and the binding 30. The slit 32 is controlled by a closure 34. FIGS. 1 through 4 illustrate the closure to be a zipper 34. FIG. 4A illustrates the closure to be hook and loop 34. FIG. 4B illustrates the closure to be button snaps 34. FIG. 4C illustrates the closure to be a magnetic closure 34 across the slit 32 with elongate flexible magnets 36, 38.

A pocket 40 is shown to be sewn to the flexible sheet 28 about the elongate slit 32. The pocket 40 extends downwardly inside the case 10. The interior of the pocket 40 is accessed through the elongate slit 32 by opening the closure 34 and spreading the flexible sheet 28 to either side. The closure 34 is to be flexible enough to bend out of the way for access to the pocket 40.

A charging device 42 for portable electronics 44, typically a power bank battery capable of being charged and used to charge an electronic device 44, is to be located in the pocket 40. Conventional ports 46 are found at one end of the power bank 42. The power bank 42, the pocket 40, the elongate hole 26 and the elongate slit 32 are to be sized for convenient size and access.

A charging cable 48 includes a charging port 50 fixed to the case 10 of charging access on the outside of the case 10. The charging port 50 is to employ a standard format such as USB and may have multiple sockets. The other end of the cable 48 includes a plug 52 located inside the pocket 40 to engage conventional ports 46. The cable 48 can conveniently extend through the wall of the pocket 40. The charging port(s) 50 can be used to charge an electronic device 44 from the power bank 42 and charge the power bank 42 for a power source (not shown) without opening the case 10 or the closure 34.

Accordingly, a system for charging portable electronics with personal cases has been disclosed. While embodiments and applications of this invention have been shown and described, it would be apparent to those skilled in the art that many more modifications are possible without departing from the inventive concepts herein. The invention, therefore, is not to be restricted except in the spirit of the appended claims.

4. A personal case comprising
a stiff shell including first and second container portions and a case closure joining the first and second container portions to define the case, the first container portion including an elongate hole therethrough;
a flexible sheet attached to the first container portion over the elongate hole, the flexible sheet including an elongate slit, the flexible sheet with the elongate slit being flexible enough to bend out of the way for access through the elongate hole in the stiff shell to the pocket;
a slit closure for the elongate slit of the flexible sheet;
a pocket fixed within the case accessible through the elongate slit;
a charging cable including a charging port fixed to the stiff shell and accessible outwardly of the case and a plug in the pocket; and
a power bank electrically engageable with the plug of the charging cable and placeable in the pocket through the elongate slit of the flexible sheet.

5. The personal case of claim 4 further comprising
a slit closure for the elongate slit of the flexible sheet, the slit closure including a zipper spanning the elongate slit.

6. The personal case of claim 4 further comprising
a slit closure for the elongate slit of the flexible sheet, the slit closure including a magnetic coupling across the elongate slit.
